(19) United States
(12) Patent Application Publication
(10) Pub. No.: US 2005/0092964 A1
(43) Pub. Date: May 5, 2005

(54) Cross-linked, long-time stable carboxymethyl starch as an absorbent for water, use of same and method for manufacture of same

(76) Inventors: Manfred Dieter Lechner, Wallenhorst (DE); Werner-Michael Kulicke, Hamburg (DE); Christoph Hess, Osnabrueck (DE); Christian Seidel, Hamburg (DE); Brigitte Hartmann, Osnabrueck (DE)

Correspondence Address: PENDORF & CUTLIFF, 5111 MEMORIAL HIGHWAY, TAMPA, FL, 33634-7356, US

(21) Appl. No.: 10/944,061

(22) Filed: Sep. 17, 2004

(30) Foreign Application Priority Data
Sep. 19, 2003 (DE) 103 43 413.5-43

(51) Int. Cl. C09K 3/00

(52) U.S. Cl. 252/194

(57) ABSTRACT

A cross-linked carboxymethyl starch is described for use as an absorbent for water, whereby the cross-linking in part or in full takes place via diether bridges, which are formed between neighbouring polymer chains.

### FIELD OF THE INVENTION

The present invention primarily concerns a new cross-linked carboxymethyl starch, which can be used as an absorbent for water and aqueous solutions. Further aspects of the present invention concern hydrogels and other products which comprise an inventive cross-linked carboxymethyl starch and methods for manufacturing the cross-linked carboxymethyl starch. Finally, the invention also concerns the use of an inventive cross-linked carboxymethyl starch as an absorbent for water or an aqueous solution.

### BACKGROUND OF THE INVENTION

Absorbents are already known that have a high absorbing capacity for aqueous fluids. These absorbents are also known as superabsorbers; they can absorb large amounts of fluid and retain these permanently. A wide range of applications exists for superabsorbers: for example, hydrogels with a superabsorber base can be used as a contact gel for medical ultrasound examinations, i.e. they can serve as the medium between the surface of the skin and the ultrasound head.

In practice to date superabsorbers based on non-reproductive raw materials have been used, which in particular are manufactured synthetically from crude oil products and are thus not at all or only hardly biologically degradable (this concerns in particular the normal polyacrylate- and polyacrylate copolymer-based superabsorbers). If used in health products or in medical applications in which direct contact with the skin is envisaged, when the superabsorbers that were previously normal in practice are used skin irritations can occur. Hydrogels which contain a superabsorber with an acrylate structure cannot be classed as generally recognised as safe, in particular since polyacrylates are included in the MEL lists as category 4 (substance with maximum exposure level) carcinogens.

Biologically degradable absorbents are already known from DE 196 54 745 C2 which are based on reproductive raw materials. The absorbents described in said document can be obtained by cross-liking an ionic carboxymethyl or carboxy-polysaccharide derivative in the presence of 10-80% by weight (in relation to the polysaccharide derivative) water at 110-180° C. Here the polysaccharide derivative is, for example, starch-based. For the cross-linking agent dicarbon-, tricarbon- or oligocarbon acids are used; accordingly with the absorbents described in DE 196 54 745 C2 it is a case of polysaccharide derivatives whose cross-linking takes place by means of ester bonds. Although the absorbents described in DE 196 54 745 C2 can be widely used in practice, they still have certain disadvantages. In particular, the absorbents synthesised from starch derivatives, during which the cross-linking of the network takes place by means of ester bonds, prove not to be long-time stable if they come into contact with water. Rather, the ester bonds are hydrolysed over time and thus the absorbent decomposes.

U.S. Pat. No. 6,322,724 B1 discloses cross-linked starch derivatives as absorbents, whereby the cross-linking takes place in part or in full via ester bonds of the —O—R—O— type, whereby R may be a hydroxy-substituted aliphatic group with 1-10 C-atoms.

EP 670 180 Al discloses absorbents which comprise, for example, carboxymethylated starch, which is cross-linked by means of a cross-linking agent such as epichlorhydrine.

EP 852 235 A2 likewise discloses carboxymethylated starch polymers that are cross-linked by means of epichlorhydrine.

DE 37 50 719 T2 discloses polysaccharides containing carboxyl cross-linked by means of ether bonds, whereby the cross-linking takes place by means of bi- or polyfunctional epoxides.

### SUMMARY OF THE INVENTION

The object of the present invention was to specify a long-time stable absorbent for aqueous fluids (water, aqueous solutions and aqueous dispersions). Advantageously the absorbent to be specified should also meet as many of the following requirements as possible:
1. The absorbent should be based on native starting substances.
2. It should be possible to form from the absorbent hydrogels with a high mechanical gel stability.
3. The absorbent and the hydrogels that can be manufactured from it should be extensively biologically degradable.
4. The absorbent and the hydrogels that can be manufactured from it should be toxicologically and dermatologically generally recognised as safe.

The object is provided inventively by specifying a cross-linked carboxymethyl starch as the absorbent, whereby the cross-linking takes place in part or in full via diether bridges of the —O—CH(COO⁻)—O—or —O—CH(COOH)—O— or —O—C(CH₃)(COO⁻)—O— or —O—C(CH₃)(COOH)—O— or —O—CH(COCH₃)—O— type, which are formed between neighbouring starch polymer chains.

The invention is based on the surprising discovery that cross-linked carboxymethyl starches, comprising cross-linked diether bridges, not only have a surprisingly high long-time stability, unlike the absorbents known from DE 196 54 745 C2, but at the same time also meet the other requirements set out above in an exceptional manner.

With the particularly preferred use of dichloroacetic acid as the cross-linking agent the cross-linking is, for example, brought about in part or in full by means of diether bridges of the —O—CH(COO⁻)—O— or —O—CH(COOH)—O— type, which is particularly advantageous. With the likewise preferred use of dichloropropionic acid as the cross-linking agent the cross-linking is brought about in part or in full by means of diether bridges of the —O—C(CH₃) (COO⁻)—O— or —O—C(CH₃) (COOH)—O— type.

Because of the inventive presence of the said types of diether bridges the inventively cross-linked carboxymethyl starches have a particularly high absorption capacity for aqueous fluids compared with known carboxymethyl starches cross-linked by means of ether bridges. This applies in particular to the carboxy functionalised diether bridges.

Advantageously the crosslinker ratio F_{z} (=ratio of the amount of cross-linking agent to the amount of anhydro glucose units) is in the range 0.025 to 0.5. This means that in the manufacture of the inventive absorbent advantageously the cross-linking agent (e.g. dichloroacetic acid) is used in a concentration of 0.025 mol-0.5 mol per 1 mol starch monomer (anhydro glucose unit). When said crosslinker ratio is adhered to the result is long-time stable absorbents with a high absorbing capacity. A particularly high free swelling capacity (FSC) is achieved if the crosslinker ratio F_{z} has a value of <0.1. Such low crosslinker ratios are therefore desired in many cases.

The degree of substitution (DS) of the inventively cross-linked carboxymethyl starch, in terms of the carboxymethyl substituents, is preferably in the range from 0.1-2 and particularly preferred in the range from 0.2-1.3. A degree of substitution of higher than 1.3 leads to increased costs, which are not acceptable in every case, in particular because higher degrees of substitution mean that not very much higher effective degrees of substitution can be achieved. A degree of substitution lower than 0.1 as a rule leads to an insufficient absorption capacity.

An inventively cross-linked carboxymethyl starch is preferably obtainable by carboxymethylation and cross-linking of native starch. For the native starch in this respect the following in particular can be used: potato starch (particularly preferred), maize starch, rice starch or wheat starch; other native starches can likewise be used.

In many cases it is, on the other hand, desired not to generate the inventively cross-linked carboxymethyl starch through carboxymethylation and cross-linking of native starch; in such cases modified and/or derivatised starch is used as a starting point.

The properties of the inventively cross-linked carboxymethyl starch vary in particular according to the degree of substitution (DS) and the crosslinker ratio F_{z}. The person skilled in the art will therefore adjust the degree of substitution and/or the crosslinker ratio as required by the intended application of the inventively cross-linked carboxymethyl starch to be manufactured.

The inventively cross-linked carboxymethyl starches have a high absorption capacity and absorption speed for aqueous fluids, even under intense pressures. Upon contact with water the outer layers of the inventively cross-linked carboxymethyl starch do not stick together and thus do not hinder the further penetration of the water into the absorbent; there is therefore no tendency towards gel blocking. The inventively cross-linked carboxymethyl starches are mechanically stable and have a high gel stability. In the swollen state the inventively cross-linked carboxymethyl starches separate extensively into individual particles.

A particular advantage of the inventively cross-linked carboxymethyl starches is that they are both long-time stable and can also be manufactured from reproductive raw materials (and are thus also generally recognised as not harmful to health and are biologically degradable). There has been no example in the state of the art to date of such a combination of properties.

The inventively cross-linked carboxymethyl starches have a well-balanced ratio between the absorbing capacity (characterised by the free swelling capacity, or FSC) and the gel stability. The inventively cross-linked carboxymethyl starches allow the absorption of an aqueous fluid even against a simultaneous pressure or against the effect of shearing forces. This is of particular importance if the inventively cross-linked carboxymethyl starches are to be used in the area of health.

As already mentioned the present invention also concerns hydrogels. An inventive hydrogel comprises an inventively cross-linked carboxymethyl starch and water. Such a hydrogel can furthermore contain (a) one or more preservatives and/or (b) glycerine and/or 1,2-propandiol (to improve the sensation on the skin).

An inventive hydrogel can be used as a contact-maker in medical examinations. Inventive hydrogels do not impede ultrasound signals or at least not to such a notable extent as conventional ultrasound gels.

In particular the inventively cross-linked carboxymethyl starches can be used as follows:
1. As lubricating gels for medical techniques (e.g. application of catheters and probes) and in the health area;
2. as sunscreen gels for the UV area;
3. as protective gels with a coolant effect against strong IR radiation (e.g. for the face when working with ovens);
4. as hydrating gels for dry skin;
5. as gels for dermal application with active substances such as anti-microbial substances;
6. as special dermatics for allergy sufferers (since the inventive hydrogels do not require any emulsifiers);
7. as swelling agents for the sustained release of active substances in oral preparations (e.g. delayed-action tablets).

The application of the inventively cross-linked carboxymethyl starches is therefore not limited to use in the area of hydrogels. On the contrary, the invention also concerns products for the absorption, retention or slow release of an aqueous fluid, i.e. water, an aqueous solution or an aqueous dispersion (in particular urine or blood), comprising an effective quantity of an inventively cross-linked carboxymethyl starch. Such products may be health products such as (single-use) nappies, incontinence or sanitary items for the absorption of (aqueous) fluids and for the containment of odours. The inventively cross-linked carboxymethyl starches can also be used in products that in a controlled manner slowly release water and possibly nutrients or active substances contained therein into an environment; this may in particular involve pharmaceutical products (controlled drug release), irrigation products for irrigation of dry land, or similar. Further inventive products that comprise an effective quantity of an inventively cross-linked carboxymethyl starch, are packaging materials and plant-growing containers. Furthermore, the inventively cross-linked carboxymethyl starches can quite generally be used in the types of products that previously comprised other absorbents (superabsorbers).

The invention also concerns a method for manufacturing an inventively cross-linked carboxymethyl starch; here the inventive method comprises the following steps:
provision of starch (native starch or a pre-treated or derivatised starch),
cross-linking and carboxymethylation of the starch to cross-linked carboxymethyl starch,
whereby alternatively
(a) the starch can initially be cross-linked and then carboxymethylated or
(b) the starch can initially be carboxymethylated and then cross-linked or
(c) the starch can be simultaneously cross-linked and carboxymethylated (one-pot method).

In many cases here the method alternatives (b) and (c) are preferred. Method alternative (c) is particularly preferred, especially over multi-stage methods, as used according to the state of the art in the manufacture of ether-cross-linked carboxymethyl starch polymers.

The starch provided is regularly alkalised before cross-linking and carboxymethylation and neutralised after the cross-linking and carboxymethylation. Such a method design simplifies the execution of the etherification reactions.

According to a particularly preferred design of the inventive method following cross-linking and carboxymethylation of the starch into the cross-linked carboxymethyl starch the remaining non-cross-linked carboxymethyl starch is separated. In order to separate the non-cross-linked starch/carboxymethyl starch from the cross-linked carboxymethyl starch the product that results following the carboxymethylation and the cross-linking is advantageously washed with water (preferably distilled or deionised water), so that the non-cross-linked polymer fractions (the non-cross-linked starch/carboxymethyl starch) are dissolved out of the inventively cross-linked carboxymethyl starch. Here the washing is advantageously repeated as often as is necessary to achieve the desired cleaning result. The washing process can be monitored in a particularly simple manner by measuring the conductivity of the washing water.

In order to manufacture the inventively cross-linked carboxymethyl starches the reaction conditions and/or the reagents are selected as required. If a diether bridge of the —O—CH(COO⁻)—O— or —O—CH(COOH)—O— or —O—C(CH₃)(COO⁻)—O— or —O—C(CH₃)(COOH)—O— or —O—CH(COCH₃)—O— type, is being manufactured, the co-reactant for the starch used is advantageously dichloroacetic acid, dichloropropionic acid or 1,1-dichloroacetone, or their salts.

Advantageously, the cross-linking reaction is designed in such a way that the ratio of the cross-linking agents (e.g. dichloroacetic acid) to the anhydro glucose units of the starch used is in the range F_{z}=0,025 to 0.5.

The quantity of carboxymethylation agent when performing the carboxymethylation reaction is advantageously selected so that a degree of substitution of the cross-linked carboxymethyl starch in relation to the carboxymethyl substituents in the preferred range of 0.1-2 is achieved, preferably a degree of substitution in the range from 0.2-1.3.

Particular preference is for an inventive method in which the dichloroacetic acid is used as a means for cross-linking the starch and/or monochloroacetic acid is used as the means for carboxymethylation of the starch. Alternatively the salts of the dichloroacetic acid and the monochloroacetic acid can also be used.

For the starch a native starch can again advantageously be used; alternatively, however, the use of modified starch and/or derivatised starch is possible.

It is advantageous to perform the conversion of the starch to the inventively cross-linked carboxymethyl starch in aqueous-alcoholic suspension.

### BRIEF DESCRIPTION OF THE DRAWING

Further details will become apparent from the following description of a preferred embodiment schematically shown in the drawing in which:

FIG. 1 is a form of a flow diagram using an example.

### DETAILED DESCRIPTION OF THE INVENTION

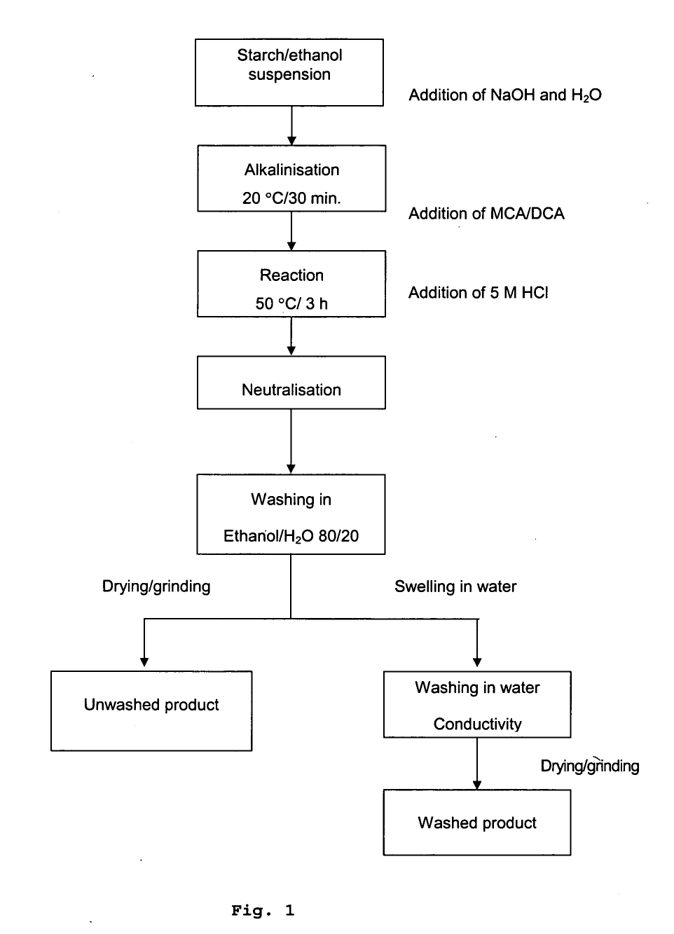

A typical process sequence for the manufacture of an inventively cross-linked carboxymethyl starch is explained in FIG. 1 in the form of a flow diagram using an example. It goes without saying that each individual indication contained in the flow diagram should be taken as an example only and that the person skilled in the art can and will deviate from the method design shown in the flow diagram in each particular case.

It has already been mentioned that following cross-linking and carboxymethylation of the starch into the cross-linked carboxymethyl starch the remaining non-cross-linked starch is advantageously separated. Advantageously the non-cross-linked starch-polymer fractions are removed from the gel matrix, by treating the raw product with water which makes it swell up. In this way non-cross-linked polymer strands are released from the gel structure and dissolved in the water. Then the cross-linked gel matrix (the inventively cross-linked carboxymethyl starch) can be separated from the non-cross-linked, dissolved polymer fractions (the remaining non-cross-linked starch/carboxymethyl starch) in a number of ways.

Particularly preferred method designs comprise a filtration step, during which a pre-swollen product mixture of used wash water (in which the non-cross-linked starch/carboxymethyl starch is present in dissolved form) is separated. Particular preference is for monitoring of the concentration of non-cross-linked starch derivatives in the wash water by means of conductivity measurement.

In our own investigations the following measures have proven particularly worthwhile:
1. After a long swelling time of, for example, 24 hours, the gel-polymer solution mixture is separated by filtration through a filter paper. The process (swelling, filtering) is repeated a number of times (2 or 3, for example).
2. The swollen reaction product (gel—polymer solution mixture) is transferred into a water-permeable bag made from acetate fabric which is then sealed. The filled bag is transferred to a jacketed water bath (temperature 40° C., distilled water), which serves as washing water. The washing process is repeated a number of times. The non-cross-linked polymer fractions (non-cross-linked starch derivatives) transferred into the washing water can be detected in the washing water by means, for example, of conductivity measurements; for the polymer strands washed out contain ionic groups which increase the conductivity of the distilled or demineralised water. Kneading the swollen reaction product (hydrogel) in the substance bag speeds up the washing process. The washing process is advantageously repeated as often as necessary until the conductivity of the washing water no longer exceeds a predetermined conductivity value of approximately 30 μS/cm. Here it is assumed that the conductivity of the fresh water is K_{H2O}<10 μS/cm. The volume of washing water here is slightly greater than is necessary for complete swelling of the gel. The non-cross-linked starch polymer contained in the washing water can be dried and undergo a cross-linking cycle.
3. As in 2, but the washing process takes place continuously under flowing washing water.
4. The swollen reaction product (hydrogel) is filled into a column which is sealed at the bottom with a glass frit. A continuous stream of distilled or demineralised water is fed to the column. Below the glass frit the washing water is collected and advantageously its conductivity is checked at regular intervals.
5. The pre-swollen reaction product (hydrogel) is transferred to a dialysis tube (preferably 14000-18000 Dalton) and cleaned in a water bath as described in 2.
6. Procedure as for 5, but with the cleaning step as described in 3.

According to the flow diagram of FIG. 1 a total of 23 example products were manufactured. Here the manufacturing process was always essentially the same and the following general process specification is sufficient.

General Process Specification:

Initially a potato starch-alcohol suspension is placed in a jacketed beaker (20° C.), which is alkalised by addition of a defined quantity of NaOH and water under vigorous agitation for 30 minutes. In addition and simultaneously the previously calculated quantities of monochloroacetic acid and dichloroacetic acid are added and the reaction mixture is heated to the desired reaction temperature under agitation. After a reaction time of 3 hours the product is drawn off and transferred into an ethanol-water mixture (80% alcohol). Next, by means of an aqueous HCl solution (5N) the pH value is adjusted to the neutral range. The salt load (NaCl) generated by the neutralisation is reduced by washing 3 times in alcohol/water (80%/20%). Then the product is transferred to pure water and after a swelling time of 24 hours fed to the washing processes until the non-cross-linked polymer fractions and the salt load have been removed almost completely in quantitative terms. The cleaned product is dried and ground. The hydrogel can then be prepared in the desired concentration with pure water, whereby the preservatives can also be added to give extended stability.

For all examples 1-23 the following applies:
MCA =monochloroacetic acid or its salts=carboxymethylation agent
DCA=dichloroacetic acid or its salts=crosslinker
AGU=anhydro glucose unit (starch monomer)
Total weight of the synthesis preparation (weight of the reactants+solvent+water)=500 g
Alkalinization ratio n_{NaOH}/n_{AGU}=3
Crosslinker ratio F_{z}=n_{DCA}/n_{AGU}=0.1 (examples 1-23 contain deviating values)
Substituent ratio s=n_{MCA}/n_{AGU}=1 (examples 1-23 contain deviating values)
Proportion of water in % by weight/total weight=15 (examples 1-23 contain deviating values)
Solvent=ethanol (other solvents are mentioned in examples 1-23)
Temperature T=50° C. (examples 1-23 contain deviating values)

### EXAMPLE 1

Product manufactured from 50 g potato starch, 29.17 g MCA, 2.01 g DCA, F_{z}=0.05

### EXAMPLE 2

Product manufactured from 50 g potato starch, 29.17 g MCA, 4.02 g DCA

### EXAMPLE 3

Product manufactured from 50 g potato starch, 29.17 g MCA, 8.04 g DCA, F_{z}=0.2

### EXAMPLE 4

Product manufactured from 50 g potato starch, 29.17 g MCA, 20.11 g DCA, F_{z}=0.5

### EXAMPLE 5

Product manufactured from 50 g potato starch, 29.17 g MCA, 1.01 g DCA, F_{z}=0.025

### EXAMPLE 6

Product manufactured from 50 g potato starch, 29.17 g MCA, 4.02 g DCA, T=78.7° C.

### EXAMPLE 7

Product manufactured from 62.50 g potato starch, 44.95 g MCA (Na salt), 5.03 g DCA, starch fraction 12.5% by weight

### EXAMPLE 8

Product manufactured from 75 g potato starch, 53.94 g MCA (Na salt), 6.04 g DCA, starch fraction 15% by weight

### EXAMPLE 9

Product manufactured from 87.5 g potato starch, 62,93 g MCA (Na salt), 7.04 g DCA, starch fraction 17.5% by weight

### EXAMPLE 10

Product manufactured from 100 g potato starch, 71.92 g MCA (Na salt), 8.05 g DCA, starch fraction 20% by weight

### EXAMPLE 11

Product manufactured from 50 g potato starch, 35.96 g MCA (Na salt), 4.02 g DCA, solvent methanol

### EXAMPLE 12

Product manufactured from 75 g potato starch, 53.94 g MCA (Na salt), 6.04 g DCA, solvent methanol, starch fraction 15% by weight

### EXAMPLE 13

Product manufactured from 100 g potato starch, 71.92 g MCA (Na salt), 8.05 g DCA, solvent methanol, starch fraction 20% by weight

### EXAMPLE 14

Product manufactured from 50 g potato starch, 35.96 g MCA (Na salt), 4.02 g DCA, solvent isopropanol (propan-2-ol), s=1

### EXAMPLE 15

Product manufactured from 50 g potato starch, 53.94 g MCA (Na salt), 4.02 g DCA, solvent isopropanol (propan-2-ol), s=1.5

### EXAMPLE 16

Product manufactured from 50 g potato starch, 71.92 g MCA (Na salt), 4.02 g DCA, solvent isopropanol (propan-2-ol), s=2

### EXAMPLE 17

Product manufactured from 50 g potato starch, 89.89 g MCA (Na salt), 4.02 g DCA, solvent isopropanol, s=2.5

### EXAMPLE 18

Product manufactured from 50 g potato starch, 107.87 g MCA (Na salt), 4.02 g DCA, solvent isopropanol, s=3

### EXAMPLE 19

Product manufactured from 50 g wax maize starch, 29.17 g MCA, 4.02 g DCA

### EXAMPLE 20

Product manufactured from 50 g wax maize starch, 29.17 g MCA, 4.02 g DCA, water fraction=12%

### EXAMPLE 21

Product manufactured from 50 g wax maize starch, 29.17 g MCA, 4.02 g DCA, water fraction=10%

### EXAMPLE 22

Product manufactured from 50 g amylomaize starch, 35.96 g MCA (Na salt), 4.02 g DCA, water fraction=10%

### EXAMPLE 23

Product manufactured from 50 g amylomaize starch, 35.96 g MCA (Na salt), 4.02 g DCA, water fraction=14%

The following Table 1 summarises essential data on the manufacturing method according to examples 1-23. In addition, Table 1 contains data on the crosslinker ratio n_{DCA}/n_{AGU} and on the determined degree of substitution. The crosslinker ratio here refers to the educts.

The significance of the columns and the abbreviations of Table 1 are explained below:

### Explanations

Column1: Example number
Column 2: Type of starch
Column 3: Initial weight of starch in grams
Column 4: Proportion by weight of the starch of the total preparation
Column 5: Initial weight of monochloroacetic acid in grams
Column 6: Substituent ratio n_{MCE}/n_{AGU}
Column 7: Initial weight of dichloroacetic acid in grams
Column 8: Crosslinker ratio F_{z}=n_{DCA}/n_{AGU}
Column 9: Reaction temperature in ° C.
Column 10: Solvent used
Column 11: Proportion by weight of the water of the total preparation
Column 12: Determined degree of substitution (DS)
Column 13: Determined free swelling capacity (FSC)
   Abbreviations:
PS=Potato starch
AM=Amylomaize starch
WM=Wax maize starch
MCA=Monochloroacetic acid
MCA/Na=Monochloroacetic acid—sodium salt
DCA=Dichloroacetic acid
S=Substituent ratio
F_{z}32 Crosslinker ratio
T=Reaction temperature
DS=Degree of Substitution

FSC=Free Swelling Capacity

TABLE 1

| No. | Starch | Starch/g | Content/% | MCA/g | S | DCA/g | F_{z} | T/° C. | Solvent | Water/% | DS | FSC |
|---|---|---|---|---|---|---|---|---|---|---|---|---|
| 1 | PS | 50 | 10 | 29.17 | 1 | 2.01 | 0.05 | 50 | Ethanol | 15 | 0.54 | 129 |
| 2 | PS | 50 | 10 | 29.17 | 1 | 4.02 | 0.1 | 50 | Ethanol | 15 | 0.53 | 125 |
| 3 | PS | 50 | 10 | 29.17 | 1 | 8.04 | 0.2 | 50 | Ethanol | 15 | 0.50 | 84 |
| 4 | PS | 50 | 10 | 29.17 | 1 | 20.11 | 0.5 | 50 | Ethanol | 15 | 0.53 | 55 |
| 5 | PS | 50 | 10 | 29.17 | 1 | 1.01 | 0.025 | 50 | Ethanol | 15 | 0.57 | 243 |
| 6 | PS | 50 | 10 | 29.17 | 1 | 4.02 | 0.1 | 78.7 | Ethanol | 15 | 0.50 | 49 |
| 7 | PS | 62.5 | 12.5 | 44.95(Na) | 1 | 5.03 | 0.1 | 50 | Ethanol | 15 | 0.49 | 77 |
| 8 | PS | 75 | 15 | 53.94(Na) | 1 | 6.04 | 0.1 | 50 | Ethanol | 15 | 0.45 | 67 |
| 9 | PS | 87.5 | 17.5 | 62.93(Na) | 1 | 7.04 | 0.1 | 50 | Ethanol | 15 | 0.43 | 56 |
| 10 | PS | 100 | 20 | 71.92(Na) | 1 | 8.05 | 0.1 | 50 | Ethanol | 15 | 0.42 | 36 |
| 11 | PS | 50 | 10 | 35.96(Na) | 1 | 4.02 | 0.1 | 50 | Methanol | 15 | 0.17 | 82 |
| 12 | PS | 75 | 15 | 53.94(Na) | 1 | 6.04 | 0.1 | 50 | Methanol | 15 | 0.27 | 112 |
| 13 | PS | 100 | 20 | 71.92(Na) | 1 | 8.05 | 0.1 | 50 | Methanol | 15 | 0.30 | 76 |
| 14 | PS | 50 | 10 | 35.96(Na) | 1 | 4.02 | 0.1 | 50 | Isopropanol | 15 | 0.44 | 66 |
| 15 | PS | 50 | 10 | 53.94(Na) | 1.5 | 4.02 | 0.1 | 50 | Isopropanol | 15 | 0.70 | 73 |
| 16 | PS | 50 | 10 | 71.92(Na) | 2 | 4.02 | 0.1 | 50 | Isopropanol | 15 | 0.93 | 95 |
| 17 | PS | 50 | 10 | 89.89(Na) | 2.5 | 4.02 | 0.1 | 50 | Isopropanol | 15 | 1.17 | 146 |
| 18 | PS | 50 | 10 | 107.87(Na) | 3 | 4.02 | 0.1 | 50 | Isopropanol | 15 | 1.25 | 215 |
| 19 | WM | 50 | 10 | 29.17 | 1 | 4.02 | 0.1 | 50 | Ethanol | 15 | 0.48 | 88 |
| 20 | WM | 50 | 10 | 29.17 | 1 | 4.02 | 0.1 | 50 | Ethanol | 12 | 0.63 | 135 |
| 21 | WM | 50 | 10 | 29.17 | 1 | 4.02 | 0.1 | 50 | Ethanol | 10 | 0.56 | 82 |
| 22 | AM | 50 | 10 | 35.96(Na) | 1 | 4.02 | 0.1 | 50 | Ethanol | 10 | | |
| 23 | AM | 50 | 10 | 35.96(Na) | 1 | 4.02 | 0.1 | 50 | Ethanol | 14 | | |

1-14. (canceled)

15. A cross-linked carboxymethyl starch suitable for use as an absorbent for an aqueous fluid, wherein
the cross-linking takes place in part or in full via diether bridges of
—O—CH(COO⁻)—O— or
—O—CH(COOH)—O— or
—O—C(CH₃)(COO⁻)—O— or
—O—C(CH₃)(COOH)—O— or
—O—CH (COCH₃)—O— type,
which bridges are formed between neighbouring starch polymer chains.

16. The cross-linked carboxymethyl starch according to claim 15, wherein the ratio of the amount of cross-linking agent to the amount of anhydro glucose units (crosslinker ratio F_{z}) is in the range 0.025 to 0.5.

17. The cross-linked carboxymethyl starch according to claim 15, wherein the degree of substitution of the cross-linked carboxymethyl starch in relation to the carboxymethyl substituents is in the range 0.1 to 2.

18. The cross-linked carboxymethyl starch according to claim 15, wherein the degree of substitution of the cross-linked carboxymethyl starch in relation to the carboxymethyl substituents is in the range 0.2 to 1.3.

19. The cross-linked carboxymethyl starch according to claim 15, obtained by carboxymethylation and cross-linking of native starch.

20. A hydrogel comprising:
water and
a cross-linked carboxymethyl starch, wherein the cross-linking takes place in part or in full via diether bridges of
—O—CH(COO⁻)—O— or
—O—CH(COOH)—O— or
—O—C(CH₃)(COO⁻)—O— or
—O—C(CH₃)(COOH)—O— or
—O—CH(COCH₃)—O— type,
which bridges are formed between neighbouring starch polymer chains.

21. The hydrogel according to claim 20 further comprising
(a) one or more preservatives and/or (b) glycerine and/or 1,2-propandiol.

22. A product for absorbing, retaining or slow release of an aqueous fluid, comprising a quantity effective for absorbing, retaining or slow release of an aqueous fluid of a cross-linked carboxymethyl starch, wherein the cross-linking takes place in part or in full via diether bridges of
—O—CH(COO⁻)—O— or
—O—CH(COOH)—O— or
—O—C(CH₃)(COO⁻)—O— or
—O—C(CH₃)(COOH)—O— or
—O—CH(COCH₃)—O— type,
which bridges are formed between neighbouring starch polymer chains.

23. A method for manufacturing a cross-linked carboxymethyl starch according to claim 15, with the following steps:
provision of starch,
cross-linking and carboxymethylation of the starch to produce cross-linked carboxymethyl starch, wherein alternatively
(a) the starch is initially cross-linked and then carboxymethylated or
(b) the starch is initially carboxymethylated and then cross-linked or
(c) the starch is simultaneously cross-linked carboxymethylated.

24. The method according to claim 23, whereby the starch provided is alkalised before cross-linking and carboxymethylation and neutralised after cross-linking and carboxymethylation.

25. The method according to claim 23, whereby following cross-linking and carboxymethylation of the starch into the cross-linked carboxymethyl starch remaining non-cross-linked carboxymethyl starch is separated.

26. The method according to one of claim 23, whereby
dichloroacetic acid and/or its salts and/or dichloropropionic acid and/or its salts is used as a means for cross-linking of the starch and/or
monochloroacetic acid is used as a means for carboxymethylation of the starch.

27. The method according to one of claims 23, whereby native starch is used for the starch.
